(19) United States
(12) Patent Application Publication
(10) Pub. No.: US 2025/0028488 A1
(43) Pub. Date: Jan. 23, 2025

(54) STORAGE MEDIUM STORING SUPPORT PROGRAM SUPPORTING GENERAL-PURPOSE PRINTING PROGRAM EMBEDDED IN OPERATING SYSTEM

(71) Applicant: BROTHER KOGYO KABUSHIKI KAISHA, Nagoya (JP)

(72) Inventors: Kenju NARITA, Nagoya (JP); Yoshito HOSOMIZO, Konan (JP)

(21) Appl. No.: 18/765,567

(22) Filed: Jul. 8, 2024

(30) Foreign Application Priority Data
Jul. 20, 2023 (JP) 2023-118214
Mar. 26, 2024 (JP) 2024-048990

(51) Int. Cl. G06F 3/12

(52) U.S. Cl. CPC G06F 3/1208; G06F 3/1253

(57) ABSTRACT

A general-purpose printing program corresponding to a printer is embedded in an operating system. The general-purpose printing program is configured to manage data for displaying a print settings screen on a display of an information processing device. A support program supports the general-purpose printing program. The support program, when executed by a computer of the information processing device, causes the information processing device to perform, when a request to perform a process is issued from the general-purpose printing program in response to the printer being selected: an acquisition process; a generation process; and a display process. The acquisition process acquires service information related to a service corresponding to the printer. The generation process generates notification data based on the service information. The display process transfers the notification data to the general-purpose printing program to have a notification image based on the notification data be displayed in the print settings screen.

### REFERENCE TO RELATED APPLICATIONS

This application claims priorities from Japanese Patent Application No. 2023-118214 filed on Jul. 20, 2023 and Japanese Patent Application No. 2024-048990 filed on Mar. 26, 2024. The entire contents of these priority applications are incorporated herein by reference.

### BACKGROUND ART

Conventional technologies have been known to use a printer driver to display service information applicable to the printer on which the printer driver is installed. Japanese Patent Application Publication No. 2006-323508 discloses a sample configuration in which a printer driver obtains location information on the printer, acquires a URL corresponding to the location information, and displays a dialog for ordering consumables in the browser based on that URL.

### SUMMARY

In recent years, practical technologies have been developed for controlling printers without the use of a printer driver. One such technology utilizes a general-purpose printing program that is embedded in the operating system (hereinafter referred to as “OS”) as standard. With this technology, the OS, upon detecting a printer, associates the printer with the OS-standard general-purpose printing program. Thereafter, when a print instruction to that printer is received, the OS-standard general-purpose printing program can control printing without the need for a printer driver.

However, none of the conventional information processing devices that use an OS-standard general-purpose printing program have a configuration for notifying the user of service information applicable to individual printers, such as printer drivers. Therefore, there is room for improvement in technologies for notifying users in an environment using an OS-standard general-purpose printing program.

In order to attain the above and other objects, according to one aspect, the present disclosure provides a non-transitory computer-readable storage medium storing a support program for an information processing device. The information processing device is connectable to a printer. The information processing device includes: a display; a computer; and a memory. The memory is configured to store therein an operating system. In the operating system, a general-purpose printing program corresponding to the printer is embedded. The general-purpose printing program is configured to manage data for displaying a print settings screen on the display. The support program supports the general-purpose printing program. The support program, when executed by the computer, causes the information processing device to perform, when a request to perform a process is issued from the general-purpose printing program in response to the printer being selected: an acquisition process; a generation process; and a display process. The acquisition process acquires service information. The service information is information related to a service corresponding to the printer. The generation process generates notification data based on the service information acquired in the acquisition process. The notification data indicates a notification content to be provided to a user. The display process transfers the notification data generated in the generation process to the general-purpose printing program to have a notification image based on the notification data be displayed in the print settings screen displayed on the display.

According to another aspect, the present disclosure also provides a non-transitory computer-readable storage medium storing a support program for an information processing device. The information processing device is connectable to a printer. The information processing device includes: a display; a computer; and a memory. The memory is configured to store therein an operating system. In the operating system, a general-purpose printing program corresponding to the printer is embedded. The support program supports the general-purpose printing program. The support program, when executed by the computer, causes the information processing device to perform, when a request to perform a process is issued from the general-purpose printing program: an acquisition process; and a display process. The acquisition process acquires service information. The service information is information related to a service corresponding to the printer. The display process displays on the display notification information based on the service information acquired in the acquisition process.

According to still another aspect, the present disclosure also provides a non-transitory computer-readable storage medium storing display program for an information processing device. The information processing device is connectable to a printer. The information processing device includes: a display; a computer; and a memory. The memory is configured to store therein: an operating system; and a support program. In the operating system, a general-purpose printing program corresponding to the printer is embedded. The support program supports the general-purpose printing program. The support program, when executed by the computer, causes the computer to perform, in response to a request to perform a process being issued from the general-purpose printing program, a start process. The start process starts the display program. The display program, when started and executed by the computer, causes the information processing device to perform: a first acquisition process; and a display process. The first acquisition process acquires service information. The service information is information related to a service corresponding to the printer. The display process displays on the display notification information based on the service information acquired in the first acquisition process.

According to still another aspect, the present disclosure further provides a non-transitory computer-readable storage medium storing a support program for an information processing device. The information processing device is connectable to a printer. The information processing device includes: a display; a computer; and a memory. The memory is configured to store therein an operating system. In the operating system, a general-purpose printing program corresponding to the printer is embedded. The support program supports the general-purpose printing program. The support program, when executed by the computer, causes the information processing device to perform, when a request to perform a process is issued from the general-purpose printing program: an acquisition process; and an output process. The acquisition process acquires service information. The service information is information related to a service corresponding to the printer. The output process has the printer output a notification image based on the service information acquired in the acquisition process.

In the above structure, the information processing device that uses an OS-standard general-purpose printing program and has the support program installed thereon can notify the user of service information related to a service applicable to a printer. As a result, the user can learn the information related to the service applicable to the printer.

Furthermore, in the above structure, the information processing device that uses an OS-standard general-purpose printing program and has the display program installed thereon can notify the user of information related to a service applicable to a printer via the support program. As a result, the user can learn the information related to the service applicable to the printer.

A display program started by the support program described above, an information processing device that has the support program and the display program installed thereon, a computer-readable storage medium storing the support program and the display program, a control method of implementing the functions of the support program and the display program, and a printing system including the information processing device that has the support program and the display program installed thereon and a printer are all novel and useful.

The present specification describes a technology employed in an information processing device with an OS-standard general-purpose printing program installed thereon, which enables the information processing device to notify the user of information related to a service applicable to a printer.

### BRIEF DESCRIPTION OF DRAWINGS

FIG. 1 is a block diagram illustrating the schematic electrical configuration of personal computer.

FIG. 2 is a sequence chart illustrating steps showing an example of an operating procedure performed when print is selected.

FIG. 3 is an explanatory diagram illustrating an example of an information screen.

FIG. 4 is an explanatory diagram illustrating an example of a print settings screen.

FIG. 5 is a flowchart illustrating steps in a notification data generation process.

FIG. 6 is an explanatory diagram illustrating an example of a notification image.

FIG. 7 is an explanatory diagram illustrating another example of the notification image.

FIG. 8 is an explanatory diagram illustrating another example of the notification image.

FIG. 9 is a sequence chart illustrating steps showing an example of an operating procedure performed when a print settings change instruction is received.

FIG. 10 is a sequence chart illustrating steps showing an example of an operating procedure performed when a print execution instruction is received.

FIG. 11 is a sequence chart illustrating steps showing another example of the operating procedure performed print is selected.

FIG. 12 is an explanatory diagram illustrating another example of the notification image.

FIG. 13 is a sequence chart illustrating steps showing another example of the operating procedure performed when print is selected.

FIG. 14 is a sequence chart illustrating steps showing another example of the operating procedure performed when print is selected.

### DESCRIPTION

Below, a personal computer (hereinafter referred to as “PC”) 1 using a support program according to a first embodiment of the present disclosure will be described while referring to the accompanying drawings. This specification describes the support program executed on the PC 1. Note that the support program can be run on smartphones and mobile computers, as well as PCs.

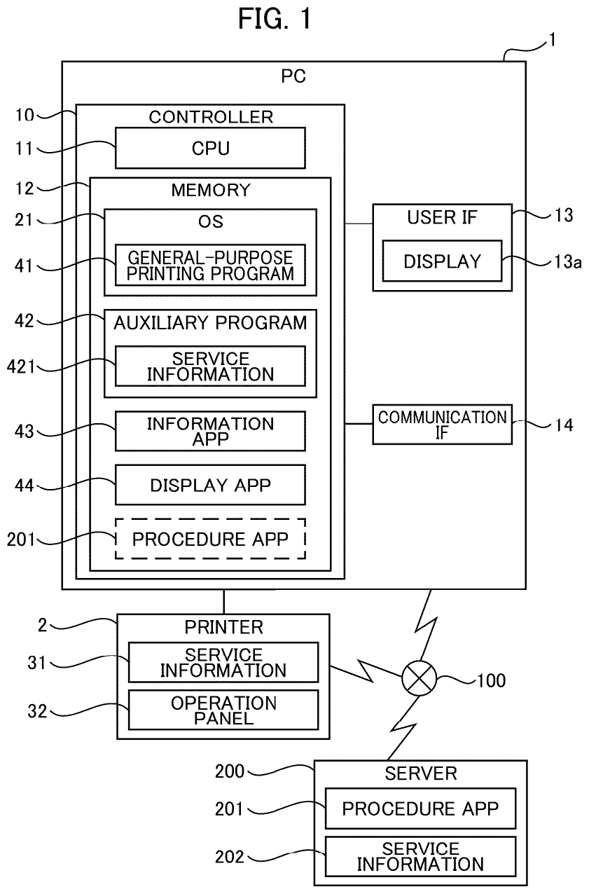

As illustrated in FIG. 1, the PC 1 of the present embodiment includes a controller 10 that includes a CPU 11 and a memory 12. The PC 1 is an example of the information processing device of the present disclosure. The CPU 11 is an example of the computer of the present disclosure. The PC 1 also includes a user interface (also described as “user IF”) 13, and a communication interface (also described as “communication IF”) 14, both of which are electrically connected to the controller 10. Note that the controller 10 in FIG. 1 is a general concept that covers all hardware and software used for controlling the PC 1 and is not actually limited to representing a single piece of hardware present in the PC 1.

The CPU 11 executes various processes according to programs read from the memory 12 or based on user operations. The memory 12 stores various programs and various data. The memory 12 is used as a work area for executing various processes. A buffer provided in the CPU 11 is also one example of a memory. Examples of the memory 12 may be a ROM, a RAM, a hard disk drive, or the like built into the PC 1 or may be any storage medium that is readable and writable by the CPU 11, such as a CD-ROM, a DVD-ROM, or other storage media.

The user interface 13 includes hardware that displays screens for reporting information to the user, and specifically a display 13a, and hardware that receives user operations. The user interface 13 may be a set of devices that includes the display 13a for displaying information, and a mouse, keyboard, and the like having input-receiving functions. Alternatively, the user interface 13 may be a touchscreen that is provided with both the display 13a and an input-receiving function.

The communication interface 14 includes hardware for communicating with an external device, such as a printer 2. The communication standard employed by the communication interface 14 may be Ethernet (registered trademark), Wi-Fi (registered trademark), Universal Serial Bus (USB), or the like. “Ethernet” is a Japanese registered trademark of FUJIFILM Business Innovation Corp. “Wi-Fi” is a Japanese registered trademark of Wi-Fi Alliance. The PC 1 may be capable of connecting to Internet 100 via the communication interface 14. Alternatively, the PC 1 may include a plurality of communication interfaces 14 supporting a plurality of communication standards.

As illustrated in FIG. 1, the memory 12 of the PC 1 stores an operating system (hereinafter referred to as “OS”) 21, a general-purpose printing program 41, which is included in the OS 21, an auxiliary program 42, and various application programs (hereinafter also abbreviated as “app(s)”). The OS 21 is one of Windows (registered trademark), macOS (registered trademark), Linux (registered trademark), iOS (registered trademark), and Android (registered trademark), for example. “Windows” is a Japanese registered trademark of Microsoft Corporation. “macOS” is a Japanese registered trademark of Apple Inc. “Linux” is a Japanese registered trademark of Linus Torvalds. “iOS” is a Japanese registered trademark of Cisco Technology Inc. “Android” is a Japanese registered trademark of Google Inc. The auxiliary program 42 is an example of the support program of the present disclosure.

Among the various application programs installed on the PC 1 of the present embodiment is an information app 43, and a display app 44, for example. The information app 43 is a map app, a calendar app, or a browser, for example. The information app 43 has a function for displaying various information on the display 13a in response to user requests. The information app 43 is an example of the application program of the present disclosure. The information app 43 itself may not have a function for printing displayed information.

The display app 44 is a program that displays information about the printer 2 on the display 13a of the PC 1, for example. The display app 44 is an example of the display program of the present disclosure. The display app 44 is started from the auxiliary program 42, for example. The display app 44 has a function for creating information to be displayed based on information acquired from the printer 2 and the like and for displaying that information.

The OS 21 includes the general-purpose printing program 41. The general-purpose printing program 41 is an OS-standard program prepared by the vendor of the OS 21 and provided as part of the OS 21. In other words, the OS 21 having the general-purpose printing program 41 is installed on the PC 1. The general-purpose printing program 41 is not configured to use printer drivers specific to individual printers.

The general-purpose printing program 41 is a program that functions to execute printing on a plurality of models of printers (printer models) respectively provided by a plurality of vendors on the basis of user instructions. The general-purpose printing program 41 supports generic functions that allow printing to be performed on many printers. Unlike printer drivers designed for specific types of printers, the general-purpose printing program 41 does not support functions that are specific to each printer or printer driver, particularly those functions that require complex processing.

The general-purpose printing program 41 is a program that includes functions for receiving image data specified as the printing target in print instructions outputted from various application programs on the basis of user instructions and for generating intermediate data based on that image data. An example of intermediate data is XML Paper Specification (XPS) data. The general-purpose printing program 41 also has a function for generating print data based on intermediate data in a format that can be used for printing on various printers. An example of print data is PWG Raster data or PDF data. The general-purpose printing program 41 also has a function for transmitting the generated print data to a printer designated as the device for executing the print via a communication function of the OS 21.

The auxiliary program 42 is a program or a set of programs that executes processes based on instructions from the OS 21 in conjunction with the processes of the general-purpose printing program 41 and is a program that provides control support for the target hardware. The auxiliary program 42 of the present embodiment supports (corresponds to) the printer model of the printer 2 connected to the PC 1 and is provided by the vendor of the printer 2, for example. The general-purpose printing program 41 starts the auxiliary program 42 supporting (corresponding to) the printer 2 in the printer 2 in the following cases: when the printer 2 is selected as the device to execute a print; when an instruction for advanced print settings is received while the printer 2 is selected; when an instruction to execute a print on the printer 2 is received; and the like. The auxiliary program 42 is called a Print Support Application (PSA) Program or a Hardware Support Application (HSA) Program, for example.

The auxiliary program 42 may be a combination of a plurality of programs, each of which receives execution commands, or may be a single program that can execute different processes according to the received commands. The vendors of printers may prepare an auxiliary program for each type of printer. For example, one auxiliary program may be prepared for inkjet printers and another auxiliary program may be prepared for laser printers. Alternatively, an auxiliary program may be prepared for each printer model or model series rather than for each type of printer.

When a new printer is connected to the PC 1, for example, the OS 21 of the PC 1 can download the appropriate auxiliary program from a server or the like based on the type or printer model of the connected printer and can install this program on the PC 1. The OS 21 stores identification information for the installed auxiliary program in the memory 12 in association with printer information on the newly connected printer.

As illustrated in FIG. 1, the PC 1 of the present embodiment is connected to a printer 2. The printer 2 is a device that possesses at least printing and communication functions. The printer 2 of the present embodiment stores service information 31. The service information 31 will be described later. The printer 2 can connect to Internet 100 and can communicate with a server 200 over Internet 100.

The printer 2 also has an operation panel 32 possessing a function for receiving user operations, and a function for displaying information. The operation panel 32 is configured of a display, and a plurality of hardware keys, for example. The display may be a liquid crystal display used for display only or may be a touchscreen that also possesses an input-receiving function.

The server 200 is a cloud server operated by the vendor of the printer 2, for example, and stores service information 202 about various services provided by that vendor. The service information 202 includes information on services provided for each of a plurality of printer models, including the printer model of the printer 2. Some possible services provided by the vendor include a subscription-based service to use a printer for a limited period of time (time period), a prepaid service to use a printer up to a limited number of sheets printed, and a service to use various extended functions configured to be non-selectable when the printer is shipped from the factory.

A “service” described herein denotes a function that requires the user to perform some procedure, such as entering a contract with the vendor or the like at the time of or after the introduction of a printer and cannot be used without having performed that procedure. Services may be paid or offered free of charge. The types of services applicable to each printer may differ according to the printer model of the printer.

The service information 202 stored on the server 200 includes information on services and consumables applicable to each printer model, information on the service usage conditions for individual printers, and information specifying the procedures for enabling services, for example. When a procedure to enable a service is performed on a printer, information from this procedure is transmitted to the server 200. The server 200 stores information on enabled services for a printer in association with identification information of the printer as service usage conditions. When an enabled service has restrictions set for the time period during which the service is available or the number of printable sheets or the like, the server 200 updates the usage conditions as needed upon receiving usage notifications from the printer.

Additionally, a procedure app 201 for performing procedures to enable various services is installed on the server 200. In response to a request from the PC 1 or the like, the server 200 provides the procedure app 201 to the requesting PC 1 or the like to be installed thereon so that the PC 1 or the like can execute the procedure app 201.

The service information 31 provided on the printer 2 is information on services corresponding to the printer 2. The service information 31 includes information indicating the types of services applicable to the printer 2, and information indicating whether each service is currently enabled, i.e., currently valid, for example. When any of the services are valid, the service information 31 also includes information specifying the start date and time indicating when the service was first used, the cumulative number of prints performed using this service; restriction information such as the time period during which the service can be used, the number of sheets that can be used, and the like; and residual information such as the remaining time period during which the service is valid, the remaining number of printable sheets, and the like, for example. The service information 31 also includes information on usage amounts of consumables based on the cumulative number of prints, the number of sheets printed, and the like. When there are no applicable services for the printer 2, the printer 2 may store information indicating there are no services as the service information 31.

The service information 31 may further include information on the printer 2 itself, such as information on the usage status of the printer 2, information on residual quantities of consumables mounted in the printer 2, and information on times and methods for replacing consumables, for example. The service information 31 that can be acquired from the printer 2 may include not only information stored on the printer 2 but also information that the printer 2 can acquire through a request to the server 200. The service information 31 may also include a URL specifying the address on Internet 100 used to access a web page (URL for a web page) at which users can enter agreements for services applicable to the printer 2, or a link with the URL embedded therein.

The auxiliary program 42 also has service information 421 on various services applicable to the printer corresponding to (supported by) the auxiliary program 42. The service information 421 provided in the auxiliary program 42 may be information acquired when the auxiliary program 42 was installed, for example. The auxiliary program 42 may also be provided to support a plurality of printer models, including the printer model of the printer 2. In this case, the service information 421 may be applicable to a plurality of printer models that the auxiliary program 42 can support. The service information 421 of the auxiliary program 42 may include information that can be acquired from the server 200 or that can be acquired from the printer 2, for example. The service information 421 may also include information specifying the types of services applicable to the printer 2, a URL for a web page at which users can enter agreements for services applicable to the printer 2, or a link with the URL embedded therein.

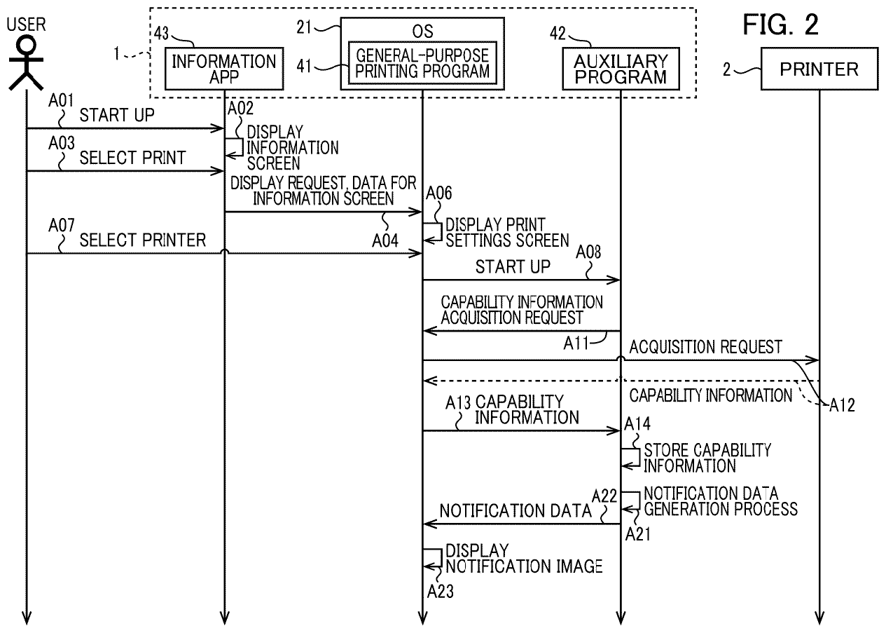

Next, a printing procedure including the operations of the auxiliary program 42 according to the present embodiment that is executed according to the various programs described above when “PRINT” is selected in the information app 43 will be described with reference to the sequence chart in FIG. 2. Note that FIG. 2 and other sequence charts described later illustrate operations performed when an auxiliary program 42 supporting (corresponding to) the printer 2 is installed on the PC 1.

The processes in the present embodiment and each process step in the sequence charts or flow charts essentially indicate processes performed by the CPU 11 according to commands described in the auxiliary program 42 and other programs. Processes performed by the CPU 11 include hardware control using the API in the OS 21. However, a detailed description of the role of the OS 21 is omitted in this specification when describing operations in the programs. Further, the term “acquire” is used as a concept that does not necessarily require a request.

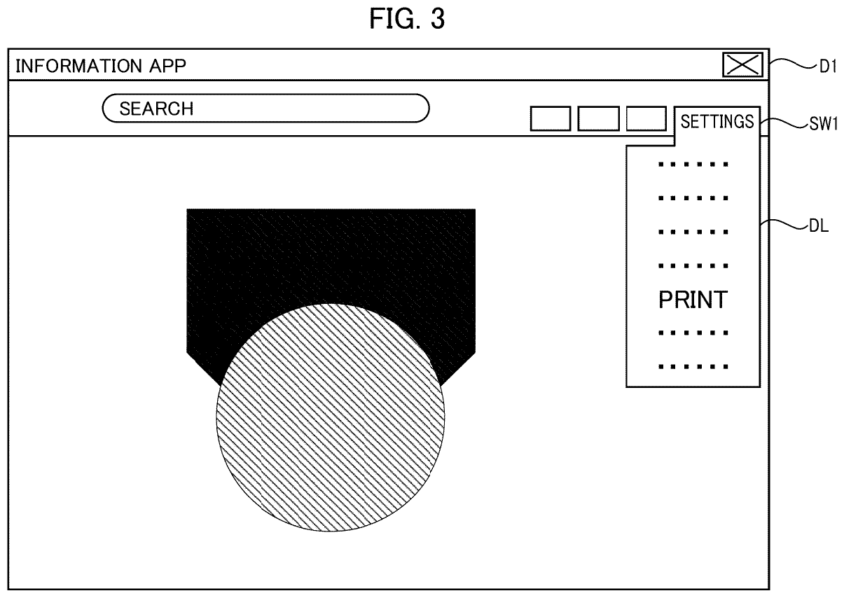

In A01 at the beginning of the procedure in FIG. 2, the user starts up the information app 43. In A02 the information app 43 displays an information screen containing various information on the display 13a in response to user instructions. When the user wishes to print an image of the information screen displayed on the display 13a, in A03 the user selects “PRINT” in the information screen. FIG. 3 illustrates an example of an information screen D1 that includes a Settings button SW1. When the user performs an operation to press the Settings button SW1, a pull-down menu DL that includes “PRINT” is displayed in the information screen D1, as illustrated in FIG. 3. When the user selects “PRINT” in the pull-down menu DL, in A04 the information app 43 passes a display request and data for the information screen to the general-purpose printing program 41 of the OS 21.

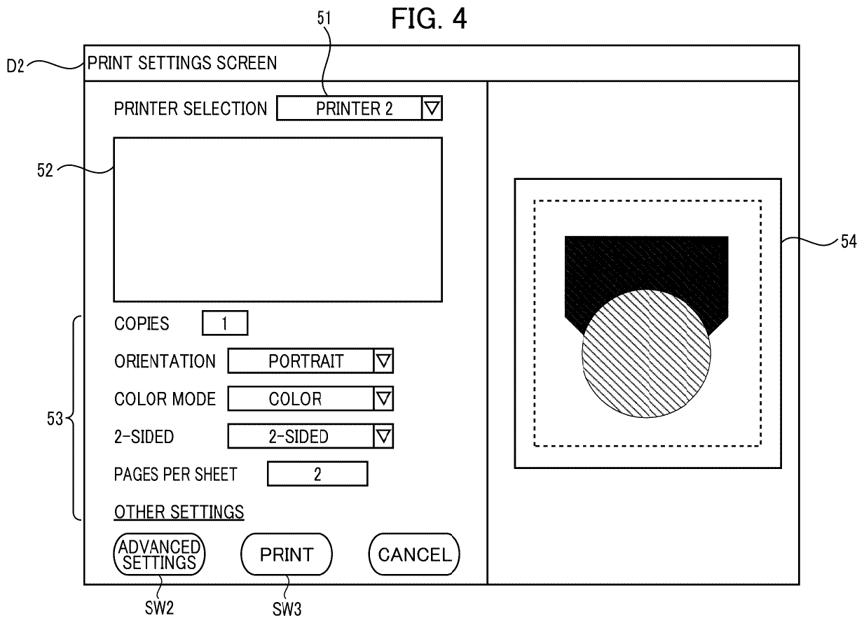

In A06 the general-purpose printing program 41 displays a print settings screen on the display 13a in response to the request. Through the print settings screen, the general-purpose printing program 41 accepts instructions to specify print settings and to execute a print. FIG. 4 illustrates an example of a print settings screen D2. The print settings screen D2 includes a printer selection menu 51 that receives a printer selection, a notification area 52 that displays a notification image, a print settings area 53 that accepts specifications for various print settings, a preview area 54 that shows an image of the information screen to be printed, an Advanced Settings button SW2 that accepts an instruction to perform advanced print settings, and a Print button SW3 that accepts an instruction to execute a print (print execution instruction). The notification image displayed in the notification area 52 shows notification content of which the user is to be informed. The general-purpose printing program 41 can manage data for displaying the print settings screen D2.

In A07 the user can select a printer in the displayed print settings screen D2 through an operation on the printer selection menu 51. When the selected printer is the printer 2, in A08 the general-purpose printing program 41 starts up the auxiliary program 42 that supports the printer 2 and requests the auxiliary program 42 to perform a process corresponding to the printer selection. In A08 the general-purpose printing program 41 also passes to the auxiliary program 42 information on the selected printer and information on print settings that have been set when the printer is selected.

When the printer 2 has been set as the default printer of the OS 21, in A06 the general-purpose printing program 41 displays the print settings screen D2 with the printer 2 already selected, as illustrated in FIG. 4, and in A08 starts up the auxiliary program 42. In other words, the OS 21 automatically selects the printer 2, and the general-purpose printing program 41 executes the process of A08 based on information on the selected printer 2. In this case, the user operation in A07 is unnecessary.

Rather than the general-purpose printing program 41 displaying the print settings screen D2, the information app 43 may be configured to display the print settings screen D2. In this case, the information app 43 starts up the general-purpose printing program 41 in response to “PRINT” being selected in A03, acquires data for displaying the print settings screen D2 from the general-purpose printing program 41, and displays the print settings screen D2 on the display 13a. In response to the printer 2 having already been selected in the print settings screen D2 or in response to the printer 2 being selected in A07, the information app 43 passes information on the selected printer 2 to the general-purpose printing program 41. In this way, the general-purpose printing program 41 starts up the auxiliary program 42 supporting the printer 2 in A08.

Once the auxiliary program 42 is started up, in A11 the auxiliary program 42 requests capability information on the printer 2 from the OS 21. Specifically, in A11 the auxiliary program 42 passes a capability information acquisition request to the OS 21. Upon receiving this capability information acquisition request from the auxiliary program 42, in A12 the OS 21 transmits an acquisition request to the printer 2 requesting capability information on the printer 2 and acquires the capability information from the printer 2. In A13 the OS 21 transfers the capability information acquired from the printer 2 to the auxiliary program 42.

The OS 21 communicates with the printer 2 according to the Internet Printing Protocol (IPP), for example. Note that rather than transmitting a request to the OS 21, the auxiliary program 42 may acquire the capability information directly from the printer 2 using a management information base (MIB), for example.

Capability information acquired from the printer 2 includes information on the possible parameters that can be specified in print settings, as well as status information, information on the residual quantities of consumables, information on mounted trays, paper information on the paper loaded in each tray, and information on supported print resolutions, for example. The printer 2 may also have functions to process images based on incoming print jobs and to print on the basis of the processed data. For example, the printer 2 may have functions to perform multiple page printing such as N-in-1 printing, composite printing with watermarks or the like, and economic printing for saving colorant. When the printer 2 possesses image processing functions that can be applied, the printer 2 may pass information on these functions to the OS 21 as capability information.

The printer 2 according to the present embodiment transmits capability information that includes the service information 31 to the OS 21 in A12. On the basis of the service information 31 contained in the capability information received from the OS 21 in A13, the auxiliary program 42 can obtain information related to services applicable to the printer 2. In this case, the process performed in A12 and A13 is an example of the acquisition process and the second acquisition process of the present disclosure.

Alternatively, the service information 31 may be acquired separately from the capability information. In this case, the auxiliary program 42 may send a request to the OS 21 to acquire the service information 31 separately from the request sent in A11, or the auxiliary program 42 may communicate directly with the printer 2 to acquire the service information 31.

Rather than acquiring the service information 31 from the printer 2, the auxiliary program 42 may acquire its own service information by reading the service information 421. Alternatively, the auxiliary program 42 may access the server 200 via the communication interface 14 and acquire the service information 202 corresponding to the printer model of the printer 2, for example. The auxiliary program 42 may acquire the service information 421 or service information 202 when the service information 31 cannot be acquired from the printer 2 in A13 or through direct communication. The auxiliary program 42 may also make attempts to acquire each of the service information 31, 421, and 202 and may use each type of acquired information in the following process.

In A14 the auxiliary program 42 stores the capability information received (notified) from the OS 21 in A13 in a prescribed area of the memory 12 that is accessible to the auxiliary program 42. When capability information has already been stored in the memory 12, the auxiliary program 42 overwrites the stored capability information with the new capability information.

In A21 the auxiliary program 42 executes a notification data generation process based on the capability information received in A13. In the notification data generation process, the auxiliary program 42 generates notification data representing a notification image to be displayed in the notification area 52 of the print settings screen D2. Notification images to be displayed in the notification area 52 may include one or a combination of text, a still image, a video, and an object having a link with an embedded URL, for example. The object may be displayed in the form of text, a button, or a banner. This notification data generation process will be described later in greater detail.

In A22 the auxiliary program 42 transfers display information including the generated notification data and information specifying values of print settings based on the capability information to the general-purpose printing program 41 and subsequently ends the process. In A23 the general-purpose printing program 41 displays a notification image in the notification area 52 of the print settings screen D2 displayed on the display 13a based on the display information received from the auxiliary program 42. In addition to displaying a notification image based on the notification data in the notification area 52, in A23 the general-purpose printing program 41 displays information in the print settings area 53 indicating initial values of the print settings based on the capability information of the printer 2. The process performed in A23 is an example of the display process of the present disclosure. Note that in a case where the information app 43 is configured to display the print settings screen D2, the information app 43 may receive the notification data in A22 and display the notification image in the notification area 52 in A23.

FIG. 4 illustrates one example of a print settings screen D2 that includes a single notification area 52, but the number of notification areas 52 as well as their arrangement, shapes, sizes, and the like are not limited to this example. The auxiliary program 42 may acquire information on the notification area 52 from the general-purpose printing program 41 and may set the notification data representing the notification image to be displayed in the notification area 52 based on the acquired information. When there are multiple layouts in which the notification area 52 can be displayed and the auxiliary program 42 can specify the display location, for example, the auxiliary program 42 may transfer notification data that includes information specifying this display location to the general-purpose printing program 41. Further, when the size of the notification area 52 can be selected, the auxiliary program 42 may transfer information specifying this size to the general-purpose printing program 41.

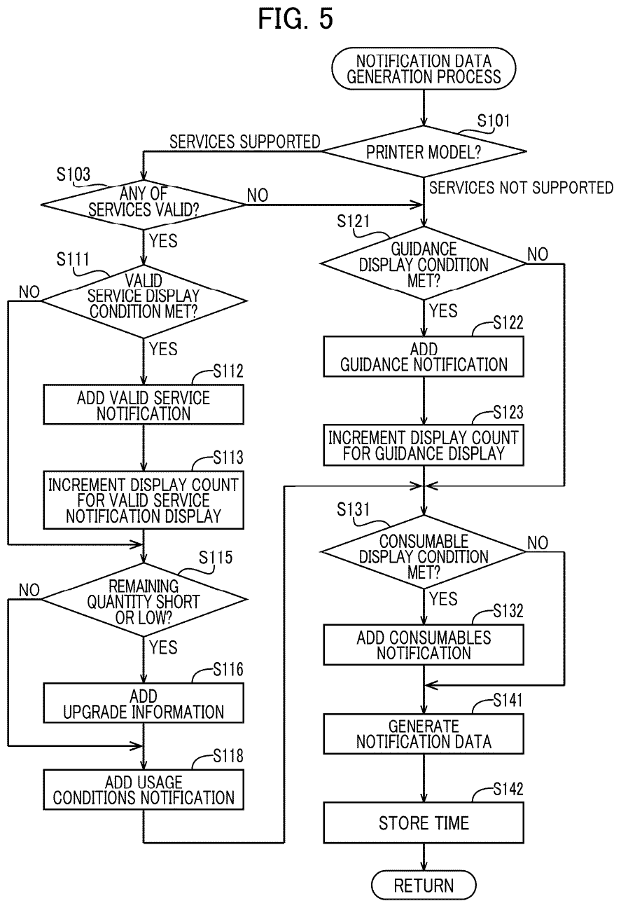

Next, steps in the notification data generation process executed in A21 will be described with reference to the flowchart in FIG. 5. The CPU 11 of the PC 1 executes this notification data generation process based on the description in the auxiliary program 42.

In S101 at the beginning of the notification data generation process, the CPU 11 determines whether the printer 2 is a printer model having any applicable services on the basis of the capability information acquired in A13 of FIG. 2 and the service information 31, 421, and 202. When the CPU 11 determines that the printer model supports services (S101: services supported), in S103 the CPU 11 determines whether any of the supported services are enabled, i.e., valid.

When the CPU 11 determines that a service is valid (S103: YES), in S111 the CPU 11 determines whether a valid service display condition is satisfied. The valid service display condition is a condition for determining whether a valid service notification will be included in the notification content. The valid service notification provides information on the valid service. For example, the CPU 11 determines whether the valid service display condition is satisfied on the basis of the number of times printing has been performed using the service, the number of times the valid service notification has been displayed, the elapsed time elapsed since the last display of the valid service notification, and the elapsed time elapsed since the start date and time indicating the first usage of the service. The valid service notification includes information indicating that the service is available, i.e., the service is in use.

The auxiliary program 42 can acquire information on the number of times printing has been performed using a service (the number of prints) for each type of service based on the service information 31 stored on the printer 2, for example. When the number of prints exceeds a predetermined limit for the number of prints (predetermined number of printing limit) for the service targeted for display, the CPU 11 determines in S111 that the valid service display condition is not satisfied. The information on the number of prints included in the service information 31 is an example of the cumulative printing number of the present disclosure, and the printing limit is an example of the prescribed value of the present disclosure.

When information on the service, i.e., a valid service notification is displayed, the auxiliary program 42 also increments and stores a display count in S113 described later. The display count represents the number of times the valid service notification has been displayed. The CPU 11 then determines in S111 that the valid service display condition is not met when the display count for the valid service notification exceeds a predetermined limit for the display count (predetermined number of display limit) for the service targeted for display. The display count is an example of the cumulative displaying number of the present disclosure, and the number of display limit is an example of the prescribed value of the present disclosure.

The auxiliary program 42 also stores the time of display (display time) when displaying the information on the service, i.e., a valid service notification in S142 described later. The CPU 11 then determines in S111 that the valid service display condition has not been met when the elapsed time elapsed since the last display time of the valid service notification based on the latest display time stored does not exceed a predetermined time interval. Note that when a display time has not been stored, the CPU 11 determines that the elapsed time exceeds the predetermined time interval.

The auxiliary program 42 can acquire information on a start date and time indicating when the service was first used based on the service information 31 stored on the printer 2 for each type of service. When the number of days elapsed since the start date and time exceeds a predetermined initial number of days for the service targeted for display, the CPU 11 determines in S111 that the valid service display condition is not satisfied. The initial number of days is an example of the prescribed time of the present disclosure.

When none of the above cases apply to the situation and the CPU 11 determines that the valid service display condition is satisfied (S111: YES), in S112 the CPU 11 adds a valid service notification to the notification content. The valid service notification includes a notification indicating that the service is valid and a notification indicating how to use the service, for example. In S113 the CPU 11 increments the display count for the valid service notification display. The process performed in S113 is an example of the storage process of the present disclosure. On the other hand, when the CPU 11 determines in S111 that the valid service display condition has not been met (S111: NO), the CPU 11 skips steps S112 and S113.

Displaying a valid service notification for a service when the service is valid, allows the user to recognize that the service is available. However, displaying information on a valid service every time the printer 2 is selected could cause the user stress. Since the auxiliary program 42 of the present embodiment determines whether to add a valid service notification to the notification content on the basis of the valid service display condition, it is unlikely that the same notification will be displayed repeatedly many times or too frequently. Therefore, the auxiliary program 42 can avoid causing the user stress due to the repeated or frequent display of valid service notifications.

In S115 the CPU 11 acquires residual information on the service based on the service information 31 and determines whether the remaining time period of validity (valid time period) for the service is short, the remaining number of printable sheets is low, or the like. When the CPU 11 determines the remaining quantity is short or low (S115: YES), in S116 the CPU 11 adds upgrade information to the notification content. Upgrade information is a notification providing guidance on extending or renewing the valid time period, increasing the number of printable sheets, and paying charges according to the prepaid method, for example.

The upgrade information may be an image containing an object with an attached link. A URL for a web page on which the user can perform the above procedures is embedded in the link, for example. When an object with an attached link in which the URL is embedded is displayed, the user can easily access the web page specified by the URL through an operation on the displayed object and can perform service procedures based on that web page.

Further, in a case where the procedure app 201 (see FIG. 1) that enables users to perform the necessary procedures for upgrades and the like related to valid services is installed on the PC 1, the upgrade information added in S116 may be an image containing an object that is associated with a start command for the procedure app 201. When such an object is displayed, the user can easily start up the procedure app 201 and perform service-related procedures using the procedure app 201.

Following S116 or when the CPU 11 determines in S115 that none of residual quantities is short or low (S115: NO), in S118 the CPU 11 adds a usage conditions notification including information on the remaining valid time period, the remaining number of printable sheets, and the like to the notification content. By providing this notification on the usage conditions of the printer 2, the user can learn how much longer the service can be used with the printer 2, for example.

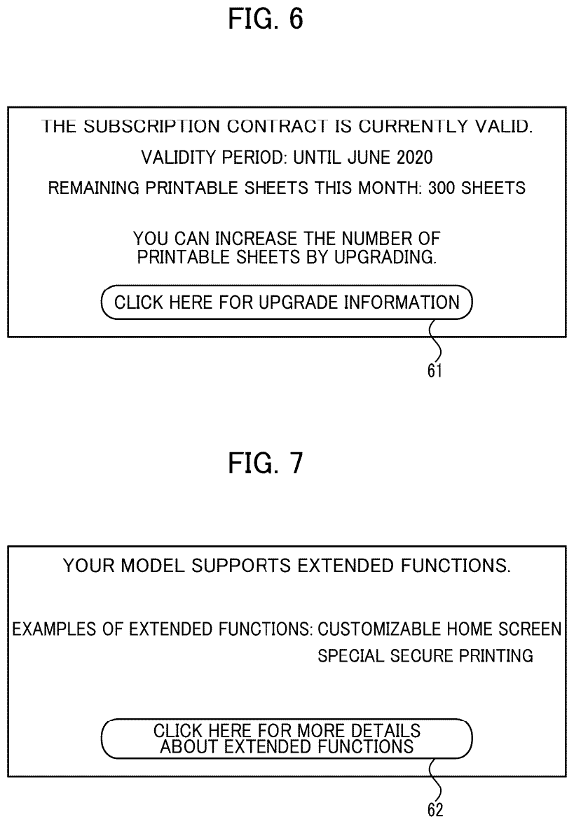

FIG. 6 illustrates an example of a notification image in a valid service notification that includes a usage conditions notification and upgrade information. The sample notification in FIG. 6 includes an object 61. A link with an embedded URL has been added to the object 61. The URL is for a web page containing upgrade information. When the notification image containing the valid service notification is displayed in the notification area 52 of the print settings screen D2, the user can easily learn the status of the printer 2 and the like from the print settings screen D2.

On the other hand, when the CPU 11 determines in S101 that the printer model of the printer 2 does not support (does not correspond to) any services (S101: services not supported) or determines in S103 that a supportable service has not been enabled (S103: NO), in S121 the CPU 11 determines whether a guidance display condition is satisfied. The guidance display condition is used to determine whether a guidance notification providing information on a service not being used is to be included in the notification content. The CPU 11 determines whether the guidance display condition is satisfied on the basis of the display count for the guidance notification and the elapsed time elapsed since the last display of the guidance notification, for example.

As with the valid service display condition, the auxiliary program 42 stores the display count for the guidance notification in S123 described later each time the guidance notification is displayed. The CPU 11 then determines in S121 that the guidance display condition is not satisfied when the display count for the guidance notification exceeds a predetermined number of display limit for the service targeted for display. In this case, the display count is an example of the cumulative displaying number of the present disclosure, and the number of display limit is an example of the prescribed value of the present disclosure.

Also, as in the case of the valid service display condition, the CPU 11 determines in S121 that the guidance display condition is not satisfied when the elapsed time elapsed since the last display of the guidance notification does not exceed a predetermined time interval.

When the CPU 11 determines that the guidance display condition is satisfied (S121: YES), in S122 the CPU 11 adds a guidance notification to the notification content. A guidance notification for a service supported by (corresponding to) the printer 2 but not yet enabled includes a notification indicating that the service can be enabled by entering an agreement, a notification specifying the procedure for enabling the service, and a notification specifying the functions enabled through use of the service, for example. When there are no services supported by the printer 2, the guidance notification may include information on printer models that support services, and a notification specifying the functions that can be enabled through use of those services, for example. In S123 the CPU 11 increments the display count for the guidance display. The process performed in S123 is an example of the storage process of the present disclosure.

When a web page containing information on enabling services is available on the server 200 or the like, the CPU 11 may add a guidance notification containing an object with an added link to the notification content, whereby the link has an embedded URL specifying that web page.

When the procedure app 201 described above is provided with a function that allows users to perform a procedure to enable services, in S122 the CPU 11 may add a guidance notification containing an object associated with a start command for the procedure app 201 to the notification content. When the procedure app 201 is not installed on the PC 1, the CPU 11 may add a guidance notification including a URL and the procedure for downloading the procedure app 201 to the notification content.

When the CPU 11 displays an object associated with a start command for a specific procedure app 201 that allows users to perform service-related procedures, the users can easily start up the procedure app 201 and perform a procedure to enable the service using the procedure app 201. The procedure app that enables users to perform procedures for enabling services may be different from the procedure app that enables users to perform procedures related to valid services.

FIG. 7 illustrates an example of a notification image in a guidance notification that contains information on services supported by (corresponding to) the printer 2 but not yet enabled. The guidance notification in the example of FIG. 7 includes information on extended functions that can be enabled through a procedure, and an object 62. A link with a URL embedded therein has been added to the object 62, where the URL specifies a web page containing information on the extended functions.

When a supported service has not been enabled, displaying guidance on that service helps the user recognize that the service can be enabled. Displaying a notification image containing a guidance notification in the notification area 52 of the print settings screen D2 increases the possibility that the user will consider using the extended functions in the notification. However, displaying guidance on supported services or guidance on other printer models each time the printer 2 is selected could create stress for the user. By determining whether to add a guidance notification to the notification content on the basis of the guidance display condition, the auxiliary program 42 of the present embodiment reduces the possibility that the same notification will be displayed repeatedly many times or displayed too frequently. Therefore, the auxiliary program 42 avoids causing the user stress due to displaying a service-related guidance notification too many times or too frequently.

Following S118 or S123, or when the CPU 11 determines in S121 that the guidance display condition has not been satisfied (S121: NO), in S131 the CPU 11 determines whether a consumable display condition is satisfied. The consumable display condition is used to determine whether to include a consumables notification containing information on residual quantities of consumables in the notification content. The auxiliary program 42 can acquire information on usage amounts or residual quantities of consumables mounted in the printer 2 and information on the time and method for replacing consumables based on the service information 31 stored on the printer 2. The CPU 11 determines that the consumable display condition is satisfied when the residual quantity of a consumable is less than a prescribed quantity.

When the CPU 11 determines that the consumable display condition is satisfied (S131: YES), in S132 the CPU 11 adds a consumables notification to the notification content. The consumables notification includes a notification of consumables whose residual quantities are low or short, an object having a link with an embedded URL that specifies a web page for purchasing the consumables, and a notification explaining how to replace the consumables, for example. Thus, the user can know it is time to replace a consumable because the CPU 11 notifies the user when the residual quantity of the consumable is low or short and near its time for replacement. On the other hand, when the CPU 11 determines that the consumable display condition is not satisfied (S131: NO), the CPU 11 does not add a consumables notification to the notification content.

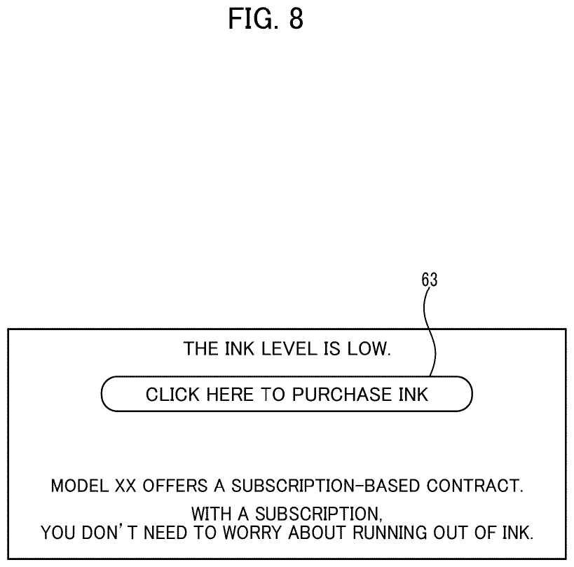

FIG. 8 illustrates an example of a notification image in a consumables notification when the printer 2 is a printer model that does not support the service and the residual quantity of ink is low. The example in FIG. 8 shows a notification image that includes a consumables notification, an object 63 having a link with an embedded URL specifying the address on Internet 100 used to access a web page to purchase ink, and a guidance notification informing the user of a printer model that supports a service not available with the printer 2. When the CPU 11 displays a notification image including this information in the notification area 52 of the print settings screen D2, the user can easily learn information related to residual quantities of consumables and the like.

The auxiliary program 42 may provide the user with information on consumables even when the residual quantities of the consumables are not lower or shorter than the prescribed amount. For example, the CPU 11 may provide a notification with information on consumables when there is no other notification content. When the CPU 11 displays information based on usage amounts of consumables, such as residual quantities of the consumables or the number of uses of the consumables, the user can estimate when the consumables will need to be replaced, for example.

In S141 the CPU 11 generates notification data representing a notification image to be displayed in the notification area 52 based on the added notification content. The process performed in S141 is an example of the generation process of the present disclosure. When a plurality of notification contents has been added, the CPU 11 may generate notification data representing a single image in which all of the added notification contents are displayed or may generate notification data for an animated display that sequentially switches the notification content being displayed. When notification contents are numerous, the CPU 11 need not display notification contents with low priority. When no notification contents have been added, the CPU 11 may generate notification data that leaves the notification area 52 blank or may generate notification data representing a preset image containing the vendor's logo or latest information, for example.

The auxiliary program 42 may also have information on various messages and objects indicating notification content, for each type of notification content, in advance. Alternatively, the auxiliary program 42 may acquire information on the messages and objects for the corresponding notification content from the printer 2 or the server 200.

As indicated in A22 of FIG. 2, the CPU 11 passes the notification data generated in S141 to the general-purpose printing program 41. Accordingly, in A23 the general-purpose printing program 41 displays a notification image based on this notification data in the notification area 52 of the print settings screen D2. In other words, the general-purpose printing program 41 displays an image based on notification data generated by the auxiliary program 42 in the print settings screen D2. In S142 the CPU 11 stores the time at which the generated notification data was passed to the general-purpose printing program 41, and subsequently ends the notification data generation process. The CPU 11 returns to the sequence chart of FIG. 2. The process performed in S142 is an example of the storage process of the present disclosure.

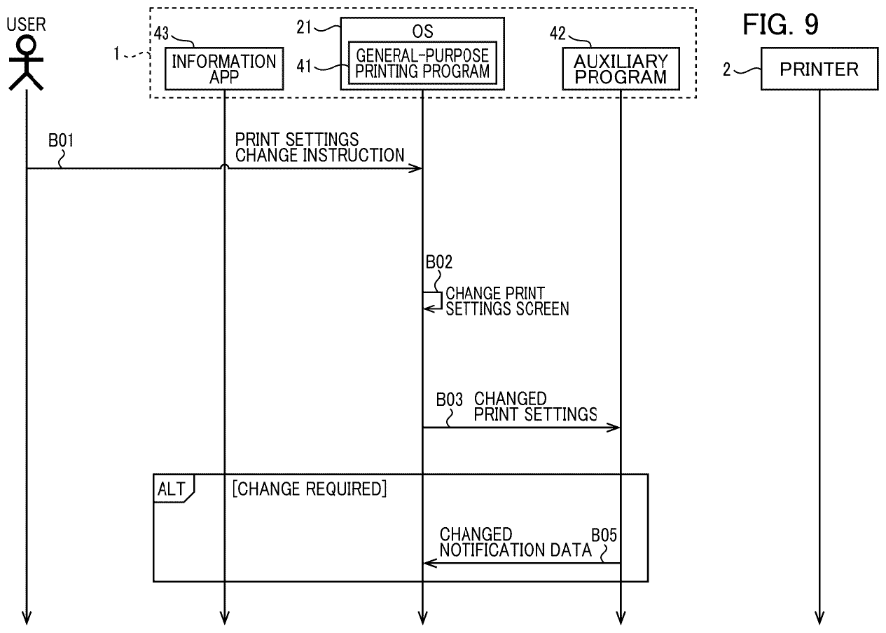

Next, the procedures of the various programs performed when an instruction to change a print setting is received through a user operation in the print settings area 53 while the print settings screen D2 illustrated in FIG. 4 is being displayed will be described with reference to the sequence chart in FIG. 9. As described above, the print settings screen D2 displayed by the general-purpose printing program 41 can receive instructions to change print settings (print settings change instruction) through operations in the print settings area 53 and a print execution instruction through an operation on the Print button SW3.

When the user issues a print settings change instruction in B01 of FIG. 9, in B02 the general-purpose printing program 41 changes the content displayed in the print settings area 53 of the print settings screen D2. When a print setting is changed, in B03 the general-purpose printing program 41 also starts up the auxiliary program 42 and requests the auxiliary program 42 to perform a process for changing the relevant print setting. In B03 the auxiliary program 42 receives information on the changed print setting from the general-purpose printing program 41.

The auxiliary program 42 determines whether the notification data representing a notification image to be displayed in the notification area 52 needs to be changed on the basis of the changed print setting. When the auxiliary program 42 determines that change is required (ALT: “CHANGE REQUIRED”), in B05 the auxiliary program 42 generates changed notification data and passes this data to the general-purpose printing program 41. Subsequently, the auxiliary program 42 ends the process in FIG. 9.

When there is a large amount of information determined to be notified in the notification data generation process of A21 in FIG. 2, for example, it may not be possible to display the entire notification image represented by the notification data in the notification area 52 at once. In such cases, the auxiliary program 42 may pass notification data representing a portion of the notification image to the general-purpose printing program 41 in A22 and may pass notification data representing the remainder of the notification image to the general-purpose printing program 41 in B05. When the auxiliary program 42 determines that the display in the notification area 52 does not need to be changed, the auxiliary program 42 skips B05 and simply notifies the general-purpose printing program 41 that the process is completed.

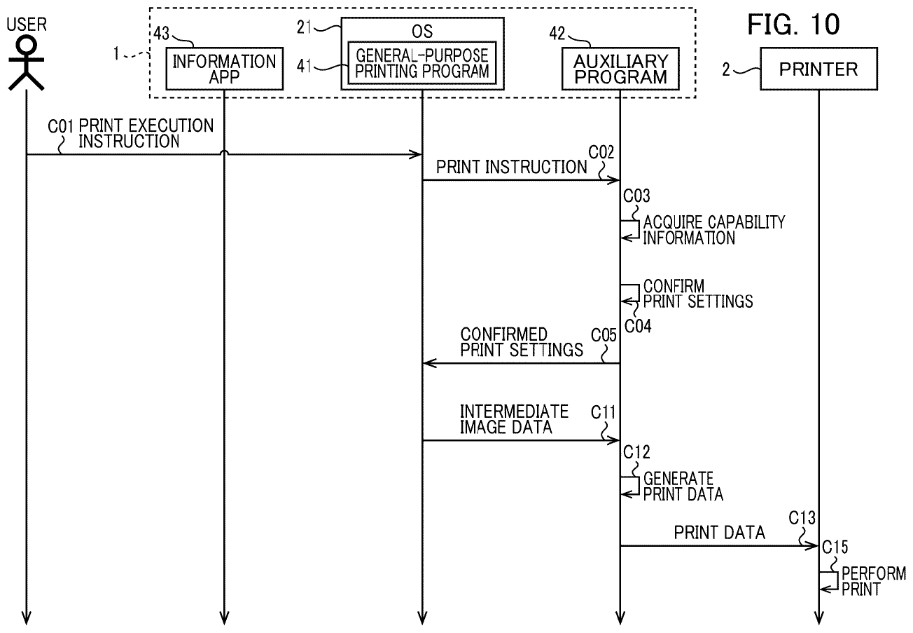

Next, the procedure performed by each program when the OS 21 receives a print execution instruction through a user operation on the Print button SW3 in the print settings screen D2 illustrated in FIG. 4 will be described with reference to the sequence chart in FIG. 10. The user may directly input the print execution instruction into the general-purpose printing program 41 or may input the print execution instruction in the information app 43, and the information app 43 may output the print execution instruction to the general-purpose printing program 41.

When the general-purpose printing program 41 receives the print execution instruction from the user in C01, in C02 the general-purpose printing program 41 starts up the auxiliary program 42 and issues a print instruction to the auxiliary program 42, requesting the auxiliary program 42 to perform a process corresponding to the print execution instruction. In C02 the auxiliary program 42 also receives information from the general-purpose printing program 41 indicating the print settings that had been set when the print execution instruction was received. The general-purpose printing program 41 may also pass image data representing an image targeted for printing to the auxiliary program 42. The general-purpose printing program 41 also closes the currently displayed print settings screen D2, thereby making the information screen of the information app 43 active.

Upon receiving the print instruction, in C03 the auxiliary program 42 acquires capability information for the printer 2 that was stored in A14 of FIG. 2. The auxiliary program 42 may also acquire capability information from the printer 2 in C03 by communicating directly with the printer 2. The capability information includes information on image processing available on the printer 2, for example. In C04 the auxiliary program 42 confirms that the print settings indicated by the information received in C02 is feasible on the basis of the capability information acquired in C03. For example, the auxiliary program 42 checks whether there are any discrepancies between the print settings and the capabilities of the printer 2 in C04. In C05 the auxiliary program 42 passes information on the print settings based on the confirmation results to the general-purpose printing program 41.

The auxiliary program 42 may also change the print settings on the basis of the confirmation results of C04 before transferring the print settings in C05. For example, when the information indicating the print settings received in C02 includes information on image processing that is more preferably performed on the printer 2 than by the general-purpose printing program 41 or auxiliary program 42, the auxiliary program 42 may change the print settings to exclude that image processing. In such cases, the auxiliary program 42 may store information on the excluded print settings so that these print settings can be transferred to the printer 2 in a later step and in C05 may transfer information on the changed print settings to the general-purpose printing program 41.

In C11 the general-purpose printing program 41 uses the print settings received from the auxiliary program 42 to generate intermediate image data by converting the format of image data for the image targeted for printing to the format of the intermediate image data and transfers this intermediate image data to the auxiliary program 42. Since the information app 43 includes image data of various types, the general-purpose printing program 41 converts the image data targeted for printing to intermediate image data that is suitable for generating print data. When the image data targeted for printing is already suitable for generating print data, the general-purpose printing program 41 may skip the process to generate intermediate image data and may use the image data itself as the intermediate image data. One example of intermediate image data is XPS data.

In C12 the auxiliary program 42 performs rasterization based on the intermediate image data received in C11 to generate print data representing an image targeted for printing. The print data generated in C12 is in a format that the printer 2 can use for printing, such as page description language (PDL) data specific to the model of printer 2.

Since the auxiliary program 42 supports the printer 2, the auxiliary program 42 has a higher degree of freedom in rasterization than the general-purpose printing program 41 and can more likely generate print data suited for printing on the printer 2. Note that the print data generated by the auxiliary program 42 may be of a format that can be used for printing on printer models other than the printer model of the printer 2.

In C13 the auxiliary program 42 transmits the print data generated in C12 to the printer 2 together with a print command instructing the printer 2 to execute a print. The process performed in C13 is an example of the transmission process of the present disclosure. When the auxiliary program 42 has determined in C04 that there is image processing to be executed on the printer 2, the auxiliary program 42 generates a print command that includes information on this processing. The auxiliary program 42 may also notify the general-purpose printing program 41 when transmission of the print data is complete.

Upon receiving the print data and print command, in C15 the printer 2 prints an image based on the print data according to the received print command, thereby generating printed matter.

The print data may be generated by the general-purpose printing program 41 rather than the auxiliary program 42. For example, the auxiliary program 42 may transfer the intermediate image data received in C11 and information on executing a print to the general-purpose printing program 41, and the general-purpose printing program 41 may generate print data by rasterizing the intermediate image data. In this case, the general-purpose printing program 41 transfers the generated print data to the auxiliary program 42. Upon receiving the print data from the general-purpose printing program 41, the auxiliary program 42 transmits the print data to the printer 2 together with a print command instructing the printer 2 to execute a print.

Print data generated by the general-purpose printing program 41 is data in an image format that various printers can use for printing, such as PWG Raster data or PDF data. Performing rasterization on the general-purpose printing program 41 reduces the processing load on the auxiliary program 42, thereby avoiding an increase in processing time and reducing the size of the auxiliary program 42.

The general-purpose printing program 41 may also transmit the print data and print command to the printer 2. That is, the auxiliary program 42 may transfer the generated print data to the general-purpose printing program 41 to be transmitted from the PC 1 with the printer 2 as the destination. In this case, the general-purpose printing program 41 transmits the print data and the like received from the auxiliary program 42 to the printer 2. In this case, the process in which the auxiliary program 42 transfers the print data and the like to the general-purpose printing program 41 is an example of the transmission process of the present disclosure.

As described above in detail, the auxiliary program 42 in the first embodiment acquires service information 31 (or service information 421 or 202), which is information on services applicable to the printer 2 (information related to services corresponding to the printer 2), generates notification data based on the acquired service information 31, 421, or 202 and transfers this notification data to the general-purpose printing program 41. In response, the general-purpose printing program 41 displays an image based on this notification data in the notification area 52 of the print settings screen D2. Accordingly, the user can learn information on services applicable to the printer 2 from the print settings screen D2.

Since the auxiliary program 42 in the present embodiment determines whether to add notifications according to the valid service display condition and guidance display condition, the same notifications are unlikely to be displayed repeatedly or frequently, which could cause the user stress. In addition, since the auxiliary program 42 of the present embodiment notifies the user of information on a valid service in the form of a notification indicating that the service is valid, a notification indicating usage conditions of the service such as the valid time period, upgrade information, and the like according to the above conditions, it is likely that the user can be informed of the necessary information. Furthermore, since the auxiliary program 42 of the present embodiment notifies the user of information on a non-valid service, such as information on services and a notification on the procedure for enabling the services and the like according to the above conditions, there is a high likelihood that the user will consider applying for the services.

The auxiliary program 42 of the present embodiment acquires at least one set of service information selected from the group consisting of the service information 31 stored on the printer 2, the service information 421 stored in the auxiliary program 42, and the service information 202 stored on the server 200, and generates notification data based on the acquired service information. By acquiring the service information 31 stored on the printer 2, the auxiliary program 42 can provide the user with information on services applicable to (corresponding to) the printer 2 and the usage conditions of services on the printer 2. By acquiring the service information 421 stored in the auxiliary program 42, the auxiliary program 42 eliminates the need to perform communication to acquire the service information, thereby reducing the impact the communication process would have on other processes. Furthermore, by acquiring the service information 202 stored on the server 200, the auxiliary program 42 can notify the user of information on the latest services provided by the vendor of the printer 2.

Next, the auxiliary program 42 according to a second embodiment of the present disclosure will be described while referring to the accompanying drawings. The second embodiment differs from the first embodiment in that rather than the general-purpose printing program 41 displaying a notification image in the notification area 52 of the print settings screen D2, the auxiliary program 42 itself performs the process for displaying this image on the user interface 13. In the following description, configurations and steps identical to those in the first embodiment will be designated with the same reference numerals and step numbers to avoid the need to repeat their descriptions. That is, the following description will focus on differences from the first embodiment.

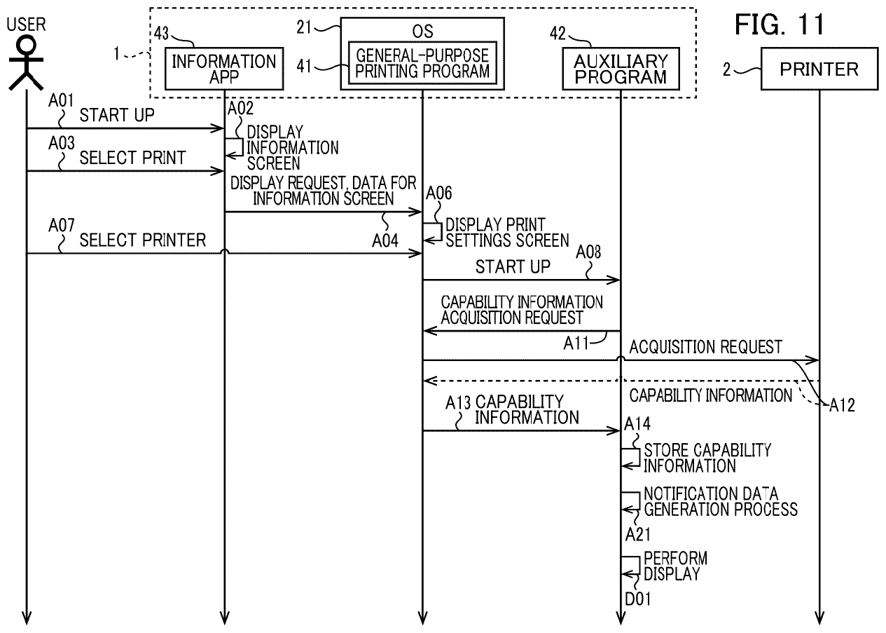

As illustrated in the sequence chart of FIG. 11, steps A01 through A21 are identical to the same steps illustrated in FIG. 2. Once these steps have been completed, in D01 the auxiliary program 42 of the second embodiment displays information on the services on the display 13a of the user interface 13 based on the notification data generated in S141 of the notification data generation process illustrated in FIG. 5. The process performed in D01 is an example of the display process of the present disclosure.

As in the first embodiment, the auxiliary program 42 in the second embodiment acquires service information, which is information on services applicable to (corresponding to) the printer 2. Specifically, the auxiliary program 42 acquires at least one of the service information 31 stored on the printer 2, the service information 421 stored in the auxiliary program 42, and the service information 202 stored on the server 200.

In D01 the auxiliary program 42 opens a new window separate from the print settings screen D2 displayed by the general-purpose printing program 41 in A06 (see FIG. 4) and displays a notification image, such as one of the images illustrated in FIGS. 6 through 8, in the new window. In this case, the auxiliary program 42 may open a window of suitable size for the notification image represented by the notification data targeted for display. The auxiliary program 42 may also pass notification data to the OS 21 so that a popup display containing the notification image is displayed separately from the print settings screen D2.

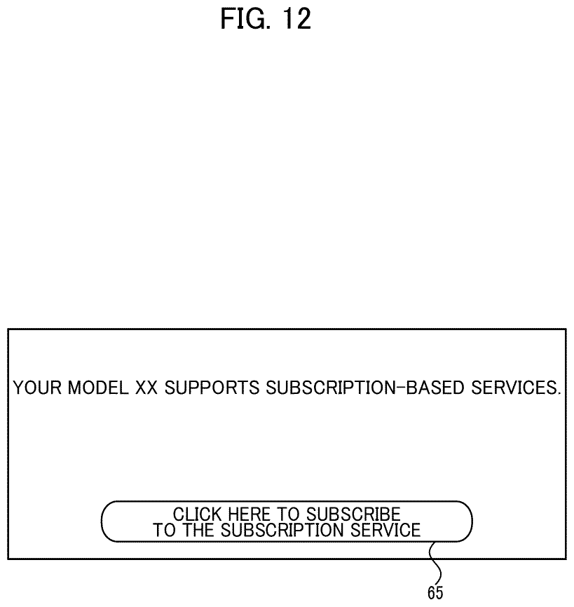

In this case, the auxiliary program 42 may display one of the notification images illustrated in FIGS. 6 through 8 or a notification image such as that illustrated in FIG. 12, for example. The notification image illustrated in FIG. 12 includes information on a service applicable to the printer 2, and an object 65 having a link with an embedded URL for a web page on which the user can enter an agreement for that service. When this notification image is displayed, a user interested in subscribing to the service can operate the object 65 to display the linked web page and, via this web page, can perform the necessary procedure to enter an agreement.

The notification data targeted for display may also be URL information specifying a web page. When the notification data is URL information, the auxiliary program 42 may launch a web browser and pass this URL information to the web browser to display the web page in the browser. For example, rather than displaying the object 62 shown in FIG. 7, the auxiliary program 42 may pass URL information for a web page containing information on extended functions to a web browser in order to display that web page.

In addition to selecting a printer, the auxiliary program 42 may display information on services when started up by the general-purpose printing program 41 based on a print execution instruction (C02 in FIG. 10). For example, the auxiliary program 42 may display different information from the content displayed in D01 in association with the selection of a printer.

As described above in detail, the auxiliary program 42 according to the second embodiment displays on the display 13a information on services applicable to (corresponding to) the printer 2. Therefore, the user can learn information on services applicable to (corresponding to) the printer 2.

Since the auxiliary program 42 of the second embodiment displays information on services itself rather than generating notification data and passing the notification data to the general-purpose printing program 41, the display process can be simplified. Furthermore, by having the auxiliary program 42 display information, information that can be displayed is not restricted by the size of the notification area 52 in the print settings screen D2 or the like. For example, various types of information can be displayed simultaneously.

Next, the display app 44 started by the auxiliary program 42 will be described as a third embodiment of the present disclosure while referring to the accompanying drawings. In this embodiment, the display app 44 displays information on services in place of the auxiliary program 42 or general-purpose printing program 41. In the following description, configurations and steps shared with the first embodiment or second embodiment will be designated with the same reference numerals and step numbers to avoid the need to repeat their descriptions. The following description will focus on points that differ from the first and second embodiments.

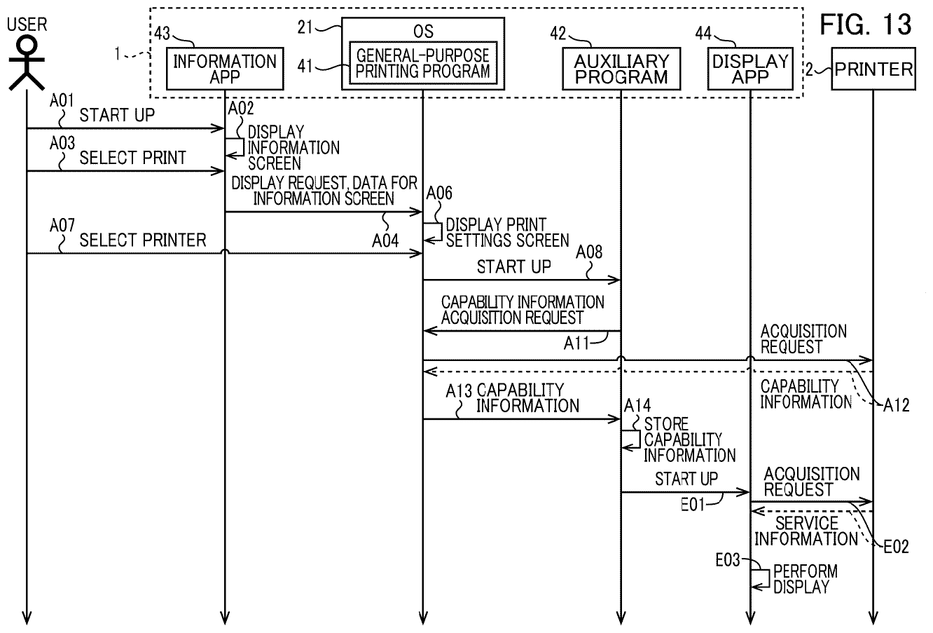

As illustrated in the sequence chart of FIG. 13, the auxiliary program 42 in the third embodiment executes the same steps A01 through A14 described in FIG. 2. Thereafter, in E01 the auxiliary program 42 starts up the display app 44. The process performed in E01 is an example of the start process of the present disclosure. As an alternative, the auxiliary program 42 may start up the display app 44 after being started itself in A08 and prior to steps A11 through A14 for acquiring capability information. The auxiliary program 42 may also start the display app 44 after being started up itself by the general-purpose printing program 41 in response to a print execution instruction (C02 of FIG. 10, for example) rather than a selection of a printer.

Upon being started by the auxiliary program 42, the display app 44 acquires various information related to services. For example, in E02 the display app 44 issues a request to the printer 2 for the service information 31 and acquires the service information 31 from the printer 2. The process performed in E02 is an example of the first acquisition process of the present disclosure.

Alternatively, the display app 44 may acquire the service information 421 from the auxiliary program 42. For example, the auxiliary program 42 may pass the service information 421 while starting up the display app 44. The display app 44 may also acquire the service information 202 corresponding to the printer model of the printer 2 from the server 200. The display app 44 may acquire any of the service information 31, 421, and 202 or a plurality of those.

In E03 the display app 44 generates notification information related to services based on the acquired service information and displays this notification information on the display 13a of the user interface 13 in a screen the display app 44 itself provides. The process performed in E03 is an example of the display process of the present disclosure.

For example, the display app 44 may generate notification information containing an image, such as those illustrated in FIGS. 6 through 8 and 12, open a new window, and display this image in the new window. Alternatively, the display app 44 may transfer this generated notification information to the OS 21 to have the OS 21 display the image in a popup display. The display app 44 may also be a web browser. When the display app 44 acquires URL information specifying a web page related to services as the service information 31, 421, or 202, the display app 44 may display this web page.

As described above in detail, the display app 44 according to the third embodiment also displays information on services applicable to (corresponding to) the printer 2 on the display 13a. Accordingly, the user can get information on services applicable to (corresponding to) the printer 2.

Using the display app 44 to display information on services can reduce the impact this display process has on printing processes performed by the auxiliary program 42 or general-purpose printing program 41. Acquiring the service information 202 from the server 200, in particular, is likely to take time, but by acquiring information from the server 200, the display app 44 can display the latest information on services from the vendor while limiting the impact on printing processes.

Next, the auxiliary program 42 according to a fourth embodiment of the present disclosure will be described while referring to the accompanying drawings. This embodiment differs from the first embodiment in which the auxiliary program 42 has the general-purpose printing program 41 display notifications, the second embodiment in which the auxiliary program 42 displays notifications itself, and the third embodiment in which the auxiliary program 42 has the display app 44 display notifications in that the auxiliary program 42 have the printer 2 make notifications about service-related information. In other words, the auxiliary program 42 performs a process to have the printer 2 output a notification image showing information on services. In the following description, configurations and steps of procedures shared with the first embodiment are designated with the same reference numerals and step numbers to avoid the need to repeat their descriptions. The following description primarily focuses on differences from the first embodiment.

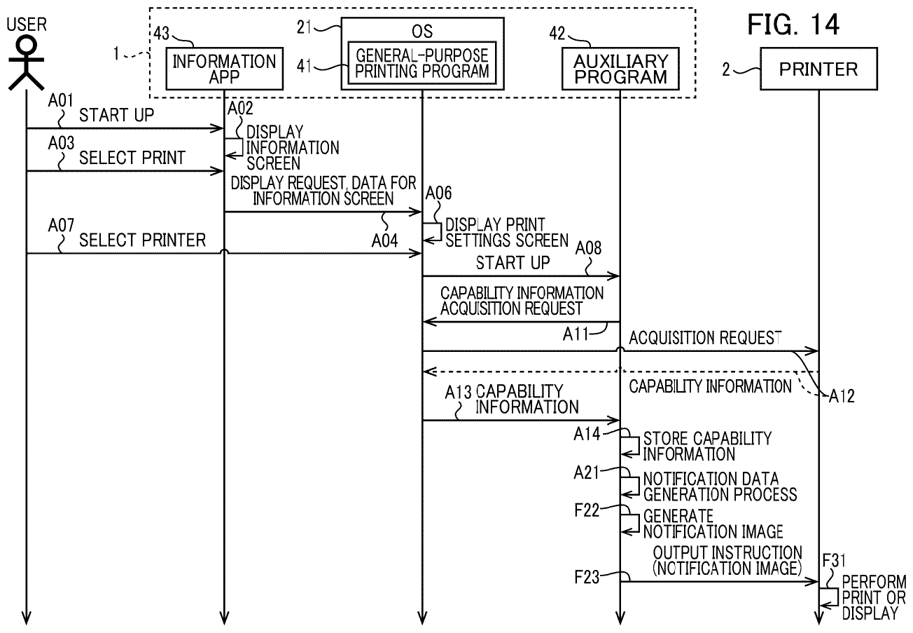

As illustrated in the sequence chart of FIG. 14, the auxiliary program 42 according to the fourth embodiment executes the same steps A01 through A21 described in FIG. 2. Subsequently, in F22 the auxiliary program 42 generates a notification image to be outputted by the printer 2 based on the notification data generated in S141 of the notification data generation process illustrated in FIG. 5. The auxiliary program 42 may acquire service information for generating the notification data from the printer 2, as indicating in A12 and A13. Alternatively, the auxiliary program 42 may acquire service information by accessing the server 200, for example, or the auxiliary program 42 itself may store service information for each printer model and may extract the service information corresponding to the printer model of the printer 2.

Following F22, in F23 the auxiliary program 42 transmits an instruction (output instruction) to the printer 2 to output the notification image. The notification image generated in F22 is associated with the output instruction and transmitted to the printer 2. As in the first through third embodiments, the notification image depicts information on services applicable to the printer 2, such as one of the notification images depicted in FIGS. 6 through 8 or 12 or an image customized for the output format of the printer 2. The process performed in F23 is an example of the output process of the present disclosure.

The format of the notification image generated in F22 depends on the output mode of the printer 2, i.e., the type of output instruction. For example, when the output instruction is a display instruction to display the notification image on the operation panel 32 of the printer 2, the auxiliary program 42 generates image data such as XPS data that can be displayed on the operation panel 32. Alternatively, when the output instruction is a print instruction to print the notification image, the auxiliary program 42 generates print data such as PDF data that is supported by the printer 2. The notification image may include a link to a web page when the operation panel 32 has a browser function. Instead of a link, a QR code (registered trademark) or other two-dimensional code storing this link may be displayed on the operation panel 32.

When the printer 2 receives an output instruction, in F31 the printer 2 extracts the notification image and outputs the image in accordance with the output instruction. For example, when the output instruction is a display instruction, the printer 2 displays the notification image on the operation panel 32. When the output instruction is a print instruction, the printer 2 prints the notification image. The auxiliary program 42 may transmit the output instruction directly to the printer 2 or through the general-purpose printing program 41.

When the auxiliary program 42 is started up from the general-purpose printing program 41 in response to a print execution instruction to execute a print (C02 of FIG. 10), the auxiliary program 42 may generate a notification image and transmit an output instruction to output that notification image to the printer 2. The auxiliary program 42 may direct the printer 2 to output a notification image containing different information from the content displayed in D01 in association with a selection of a printer.

As described above in detail, the auxiliary program 42 according to the fourth embodiment has the printer 2 output information on services applicable to (corresponding to) the printer 2. Accordingly, the user can learn information on services applicable to (corresponding to) the printer 2.

The auxiliary program 42 according to the fourth embodiment has the printer 2 notify the user of information on services rather than the PC 1. Accordingly, when the notification image is displayed on the operation panel 32, for example, the user can learn of this information on services when operating the printer 2. When the notification image is printed, for example, the information that can be outputted is not restricted by the size of the notification area 52 in the print settings screen D2 or the like, and the printer 2 can print many types of information on a single sheet.

The auxiliary program 42 can control the printer 2 to issue a notification of service information as described in the fourth embodiment in addition to the notification of service information issued by the PC 1 as described in one of the first through third embodiments.

The embodiments disclosed in this specification are merely examples and are not intended to limit the present disclosure in any way. Therefore, it would be apparent to those skilled in the art that various improvements and modifications may be made to the technology disclosed in this specification without departing from the spirit of the disclosure. For example, the device connected to the PC 1 is not limited to a printer, but may be a multifunction peripheral, a copier, a fax machine, or any other device having a printing function. Furthermore, the number of devices connected to the PC 1 may be any number of two or greater and is not limited to the example shown in the drawings.

The notification images illustrated in FIGS. 6 through 8 and 12 are merely examples, and the present disclosure is not limited to these sample images. Further, any of various wordings, object shapes, backgrounds, and the like may be displayed in the notification image.

In the above embodiments, the CPU 11 determines the content of notifications to be added and whether to add those notifications according to various conditions, such as whether the printer model of the printer 2 supports (corresponds to) any services, whether a supported service is valid, and whether the valid service display condition and the guidance display condition are satisfied, but these conditions may be eliminated. That is, information on various services may be displayed regardless of the printer model and service status of the printer 2.

The general-purpose printing program 41 may also start up the auxiliary program 42 after displaying the print settings screen D2 when the default printer is changed from another printer to the printer 2 through the OS 21 in response to a user operation. In this case, the auxiliary program 42 may perform a process to display information on services, just like when the printer 2 is selected. Specifically, the auxiliary program 42 may execute the notification data generation process and may pass notification data to the general-purpose printing program 41, execute a display according to the notification data by itself, or start the display app 44 to execute a display according to the notification data.

In the embodiments described above, only printing operations have been described in detail as the operations of the auxiliary program 42, but the auxiliary program 42 may have other roles. Furthermore, the program that executes the processes described in the embodiments is not limited to the auxiliary program 42 but may be another program that receives instructions from the OS 21 or the general-purpose printing program 41 when printing is performed using the general-purpose printing program 41. For example, a print workflow application program having specifications published by Microsoft Corporation may be used as the program.

The execution timing of the auxiliary program 42 is not limited to the examples in the embodiments. For example, the auxiliary program 42 may be executed in response to execution instructions received directly from the OS 21. Alternatively, the auxiliary program 42 may be a resident program, in which case the auxiliary program may perform the operations described above upon receiving an execution command.

In any of the sequence charts and flow charts disclosed in the embodiments, the plurality of processes that make up any of the plurality of steps may be executed in parallel, or the order in which the processes are performed may be modified in any way that does not produce any inconsistencies in the processes.

The processes disclosed in the embodiments may be executed by a single CPU, a plurality of CPUs, an ASIC or other hardware, or a combination of these components. Further, the processes disclosed in the embodiments may be achieved through a storage medium that stores the programs used to implement those processes or according to any of various other methods or formats.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. A non-transitory computer-readable storage medium storing a support program for an information processing device connectable to a printer, the information processing device including: a display; a computer; and a memory configured to store therein an operating system in which a general-purpose printing program corresponding to the printer is embedded, the general-purpose printing program being configured to manage data for displaying a print settings screen on the display, the support program supporting the general-purpose printing program, the support program, when executed by the computer, causing the information processing device to perform, when a request to perform a process is issued from the general-purpose printing program in response to the printer being selected:
an acquisition process acquiring service information, the service information being information related to a service corresponding to the printer;
a generation process generating notification data based on the service information acquired in the acquisition process, the notification data indicating a notification content to be provided to a user; and
a display process transferring the notification data generated in the generation process to the general-purpose printing program to have a notification image based on the notification data be displayed in the print settings screen displayed on the display.

2. The non-transitory computer-readable storage medium according to claim 1,
wherein the support program has the service information corresponding to the printer currently connected to the information processing device, and
wherein the acquisition process acquires the service information corresponding to a printer model of the printer currently connected to the information processing device.

3. The non-transitory computer-readable storage medium according to claim 1,
wherein the information processing device is connectable to a server, the server being configured to store therein at least one set of the service information in association with respective ones of at least one printer model, and
wherein the acquisition process acquires from the server the service information corresponding to a printer model of the printer currently connected to the information processing device.

4. The non-transitory computer-readable storage medium according to claim 1,
wherein the service is available on the printer under a usage condition, the service information including usage condition information indicating the usage condition, and
wherein the generation process generates the notification data based on the usage condition information included in the service information, the notification data generated in the generation process indicating the notification content including the usage condition.

5. The non-transitory computer-readable storage medium according to claim 1,
wherein the service information includes validity information indicating whether the service is valid, and
wherein when the validity information indicating that the service is valid is included in the service information acquired in the acquisition process, the generation process generates the notification data indicating the notification content including information indicating that the service is available, and
wherein when the validity information indicating that the service is valid is not included in the service information acquired in the acquisition process, the generation process generates the notification data indicating the notification content including a guidance of the service.

6. The non-transitory computer-readable storage medium according to claim 1,
wherein the service information includes validity information indicating whether the service is valid,
wherein the support program, when executed by the computer, causes the information processing device to perform, when the request is issued from the general-purpose printing program in response to the printer being selected:
the acquisition process; and
when the validity information indicating that the service is valid is not included in the service information acquired in the acquisition process:
the generation process generating the notification data including information indicating a guidance of the service; and
the display process, and
wherein when the validity information indicating that the service is valid is included in the service information acquired in the acquisition process, the generation process and the display process are skipped.

7. The non-transitory computer-readable storage medium according to claim 1,
wherein the notification content indicated by the notification data generated in the generation process includes a link in which a URL is embedded, the URL specifying an address used to access a specific web page, the specific web page including information specifying a procedure related to the service.

8. The non-transitory computer-readable storage medium according to claim 1,
wherein the service information includes a cumulative printing number indicating a total number of prints performed on the printer,
wherein the support program, when executed by the computer, causes the information processing device to perform, when the request is issued from the general-purpose printing program in response to the printer being selected:
the acquisition process; and
when the cumulative printing number included in the service information acquired in the acquisition process is smaller than or equal to a prescribed value:
the generation process; and
the display process, and
wherein when the cumulative printing number included in the service information acquired in the acquisition process is greater than the prescribed value, the generation process and the display process are skipped.

9. The non-transitory computer-readable storage medium according to claim 1,
wherein the support program, when executed by the computer, causes the information processing device to further perform:
a storage process storing a cumulative displaying number in the memory, the cumulative displaying number indicating a total number of times that the notification image has been displayed in the print settings screen,
wherein the support program, when executed by the computer, causes the information processing device to perform, when the request is issued from the general-purpose printing program in response to the printer being selected:
the acquisition process; and
when the cumulative displaying number stored in the memory in the storage process is smaller than or equal to a prescribed value:
the generation process; and
the display process, and
wherein when the cumulative displaying number stored in the memory in the storage process is greater than the prescribed value, the generation process and the display process are skipped.

10. The non-transitory computer-readable storage medium according to claim 1,
wherein the service information includes start date and time information indicating a start date and time of first usage of the service,
wherein the support program, when executed by the computer, causes the information processing device to perform, when the request is issued from the general-purpose printing program in response to the printer being selected:
the acquisition process; and
when an elapsed time since the start date and time indicated by the start date and time information included in the service information acquired in the acquisition process is less than or equal to a prescribed time:
the generation process; and
the display process, and
wherein when the elapsed time is more than the prescribed time, the generation process and the display process are skipped.

11. The non-transitory computer-readable storage medium according to claim 1,
wherein the memory is configured to further store an application program, and
wherein the support program, when executed by the computer, causes the information processing device to further perform, when an instruction instructing the general-purpose printing program to print an image with the printer is issued from the application program:
a transmission process acquiring image data representing the image from the general-purpose printing program and transmitting a print command based on the image data to the printer.

12. A non-transitory computer-readable storage medium storing a support program for an information processing device connectable to a printer, the information processing device including: a display; a computer; and a memory configured to store therein an operating system in which a general-purpose printing program corresponding to the printer is embedded, the support program supporting the general-purpose printing program, the support program, when executed by the computer, causing the information processing device to perform, when a request to perform a process is issued from the general-purpose printing program:
an acquisition process acquiring service information, the service information being information related to a service corresponding to the printer; and
a display process displaying on the display notification information based on the service information acquired in the acquisition process.

13. The non-transitory computer-readable storage medium according to claim 12,
wherein the printer is configured to store therein the service information, and
wherein the acquisition process acquires the service information from the printer currently connected to the information processing device.

14. The non-transitory computer-readable storage medium according to claim 12,
wherein the information processing device is connectable to a server, the server being configured to store therein at least one set of the service information in association with respective ones of at least one printer model, and
wherein the acquisition process acquires from the server the service information corresponding to a printer model of the printer currently connected to the information processing device.

15. A non-transitory computer-readable storage medium storing a display program for an information processing device connectable to a printer, the information processing device including: a display; a computer; and a memory configured to store therein: an operating system in which a general-purpose printing program corresponding to the printer is embedded; and a support program supporting the general-purpose printing program, the support program, when executed by the computer, causing the computer to perform, in response to a request to perform a process being issued from the general-purpose printing program, a start process starting the display program, the display program, when started and executed by the computer, causing the information processing device to perform:
a first acquisition process acquiring service information, the service information being information related to a service corresponding to the printer; and
a display process displaying on the display notification information based on the service information acquired in the first acquisition process.

16. The non-transitory computer-readable storage medium according to claim 15,
wherein the printer is configured to store therein the service information, and
wherein the first acquisition process acquires the service information from the printer currently connected to the information processing device.

17. The non-transitory computer-readable storage medium according to claim 15,
wherein the information processing device is connectable to a server, the server being configured to store therein at least one set of the service information in association with respective ones of at least one printer model, and
wherein the first acquisition process acquires from the server the service information corresponding to a printer model of the printer currently connected to the information processing device.

18. The non-transitory computer-readable storage medium according to claim 15,
wherein the support program, when executed by the computer, causing the information processing device to perform, in response to the request being issued from the general-purpose printing program in response to the printer being selected, a second acquisition process acquiring the service information, and
wherein the first acquisition process acquires from the support program the service information acquired in the second acquisition process.

19. A non-transitory computer-readable storage medium storing a support program for an information processing device connectable to a printer, the information processing device including: a display; a computer; and a memory configured to store therein an operating system in which a general-purpose printing program corresponding to the printer is embedded, the support program supporting the general-purpose printing program, the support program, when executed by the computer, causing the information processing device to perform, when a request to perform a process is issued from the general-purpose printing program:
an acquisition process acquiring service information, the service information being information related to a service corresponding to the printer; and
an output process having the printer output a notification image based on the service information acquired in the acquisition process.

20. The non-transitory computer-readable storage medium according to claim 19,
wherein the support program has the service information corresponding to the printer currently connected to the information processing device, and
wherein the acquisition process acquires the service information corresponding to a printer model of the printer currently connected to the information processing device.

21. The non-transitory computer-readable storage medium according to claim 19,
wherein the information processing device is connectable to a server, the server being configured to store therein at least one set of the service information in association with respective ones of at least one printer model, and
wherein the acquisition process acquires from the server the service information corresponding to a printer model of the printer currently connected to the information processing device.

22. The non-transitory computer-readable storage medium according to claim 19,
wherein the output process has the printer display the notification image on a display device of the printer.

23. The non-transitory computer-readable storage medium according to claim 19,
wherein the output process has the printer print the notification image.
